(19) United States
(12) Patent Application Publication
(10) Pub. No.: US 2007/0157698 A1
(43) Pub. Date: Jul. 12, 2007

(54) System and method for the elastic properties measurement of materials

(76) Inventors: Claude Allaire, St.-Eustache (CA); Alain Carbonneau, Deux-Montagnes (CA)

Correspondence Address: MUIRHEAD AND SATURNELLI, LLC, 200 FRIBERG PARKWAY, SUITE 1001, WESTBOROUGH, MA, 01581, US

(21) Appl. No.: 10/568,238

(22) PCT Filed: Aug. 11, 2004
(86) PCT No.: PCT/CA04/01493

§ 371 Date: Jul. 17, 2006

(30) Foreign Application Priority Data
Aug. 14, 2003 (CA) 2437323

(51) Int. Cl. G01N 3/30

(52) U.S. Cl. 73/12.01

(57) ABSTRACT

For heterogeneous materials such as refractories and carbon electrodes, the measurement the elastic properties of the material is difficult to achieve with high level of repeatability. The present invention is directed to a method and system for the elastic properties measurement of a material including the Elastic and Shear Modulus, as well as the Poisson's ratio of heterogeneous materials, at room and high temperature, according to a non destructive acoustic technique. The system comprises impacting devices for impacting a sample of the material so as to produce acoustic vibrations in the sample; acoustic detection devices so positioned relatively to the sample and the impacting device to capture the acoustic vibrations and to produce signals indicative of the acoustic vibrations; and a controller coupled to both the impacting devices and the acoustic detection device for controlling the impacting device, for receiving the signals from the acoustic detection devices and for using the signals to determine an elastic property of the material.

### FIELD OF THE INVENTION

The present invention relates to properties measurement of materials.

More specifically, the present invention concerns a system and method for non-destructive elastic properties measurement of materials.

### BACKGROUND OF THE INVENTION

Acoustic testing is based on time-varying deformations or vibrations in materials, such deformations and vibrations being generally referred to as acoustic. All materials being comprised of atoms, which may be forced into vibrational motion from their equilibrium positions, many different patterns of vibrational motion exist at the atomic level. However, most are irrelevant to acoustic testing. Such testing is focused on particles that contain many atoms that move in unison to produce a mechanical wave. Provided a material is not stressed in tension or compression beyond its elastic limit, its individual particles exhibit elastic oscillations.

In solid bodies, sound waves can propagate under different modes that are based on the way the particles oscillate. Sound can propagate as longitudinal waves, shear waves, surface waves, and in thin materials as plate waves. Longitudinal and shear waves are the two modes of propagation most widely used in acoustic testing.

When an elastic material is impacted, it resonates at a given natural frequency, which is a function of its elastic properties, i.e., E (Elastic or Young's modulus), G (Shearing or Coulomb's modulus) and v (Poisson's ratio). The relationship between these properties is given by the following equation:

$$G = \frac{E}{2 ( 1 + v )} \qquad ( 1 )$$

The natural resonance frequency, f, is reached when a stationary acoustic wave, of wavelength λ/2 and velocity V, is created in the material, where:
V=λ·f=2·L·f=2·L/T (2)

In the above equations, L is a representative material's dimension, such as the length of a thin section cylinder, and T is the resonance period.

The calculation of the elastic constants from measured resonance periods can be achieved according to Spinner and Tefft [1].

Knowledge of the elastic properties of material is of prime importance. These properties not only reflect the extent of bonding in the material, but also permit characterization of its behavior under stress, according to the following equations:

$$\begin{matrix}σ = E ɛ = E \frac{Δ L}{{L}_{0}} & ( 3 ) \\ τ = G γ = G \frac{Λ u}{{L}_{0}} & ( 4 ) \\ v = - ( \frac{Δ r}{Δ L} ) ( \frac{{L}_{0}}{{r}_{0}} ) & ( 5 )\end{matrix}$$

where ε and γ are the material's tensile and shear strain under the action of the applied tensile, σ, and shear, τ, stress, respectively.

Refractories and carbon electrodes are examples of heterogeneous materials containing pores, cracks and multi-phases aggregates. Such materials are generally exposed in service to mechanical abuse such as thermal shock, mechanical impact, abrasion and erosion. The foregoing promotes microstructural changes in the materials affecting their properties and consequently their behavior in service.

Non-destructive acoustic testing is commonly used to characterize the microstructure of homogeneous materials such as fine ceramics and metals. However, it is usually difficult to apply such technique to refractories and carbon electrodes, and other such materials, due to their heterogeneous nature. Different acoustic techniques for the characterization of such heterogeneous materials are known in the art [3-9]. The following two categories of techniques are more specifically used in characterizing heterogeneous materials; the propagation techniques and the resonance techniques.

The propagation techniques involve forcing an acoustic pulse to propagate into a sample under longitudinal mode. The reflected pulses at the sample's opposite boundaries along the propagation direction are collected and are used to calculate the acoustic pulse velocity, which is then used to determine the longitudinal elastic modulus of the sample. Such techniques can be applied both at room and high temperature. However, in the later instance, the use of waveguides between the samples and the acoustic pulse emitter and receiver makes it difficult to detect the appropriate reflected pulses due to multiple reflections at each additional interfaces introduced by the waveguides.

In the resonance techniques, a sample is forced to vibrate either by the action of an imposed continuous acoustic wave or by the action of an impact. These techniques are currently referred as IET (impulse excitation technique) and resonant techniques, respectively. In both cases, the resonance frequency of the sample is collected and is used to calculate its elastic properties. The IET technique is currently more limited to the measurement of the flexural elastic properties of materials, both at room and high temperature.

In the resonant technique, the sample is impacted by the action of a dropping ceramic or metallic ball, or by the action of a manual hammer. The sample's resonance period is then collected using a standard piezoelectric transducer or microphone. However, none of the reported apparatus and set-up thereof using the resonant technique allows the high temperature measurements of the overall set of elastic properties, e.g., the Elastic Modulus, the Shear Modulus and the Poisson's ratio. An example of a reported apparatus allowing such overall measurements at room temperature is the GrindoSonic™ apparatus commercialized by the company J.W. Lemmens, Inc.

The GrindoSonic™ apparatus consists of a module that converts the signal collected by a piezoelectric transducer to vibration periods, when a sample is manually impacted at room temperature under three distinct vibration modes; namely, longitudinal, flexural and torsional. According to the manufacturer, the period values issued from the module are the average of eight consecutive resonance periods collected from the tested sample. Software is then used to calculate the elastic constants from these periods. This apparatus has more recently been used for high temperature testing of the flexural elastic modulus of refractory materials using one pneumatic hammer and one microphone [2].

### SUMMARY OF THE INVENTION

According to a first aspect of the present invention, there is provided a system for the elastic properties measurement of a material comprising:
at least one impacting device for impacting a sample of the material so as to produce acoustic vibrations in the sample;
at least one acoustic detection device so positioned relatively to the sample and the impacting device to capture the acoustic vibrations and to produce signals indicative of the acoustic vibrations; and
a controller coupled to both the at least one impacting device and the at least one acoustic detection device for controlling the impacting device, for receiving the signals from the at least one acoustic detection device and for using the signals to determine an elastic property of the material.

According to a second aspect of the present invention, there is provided an impacting device for causing vibration of a sample of a material in view of measuring an elastic property of the material, the device comprising:

an impacting tip defining a longitudinal axis; and

an actuator for moving the impacting tip along the longitudinal axis; the impacting tip being mounted to the actuator via a rod.

According to a third aspect of the present invention, there is provided an acoustic detection device for elastic properties measurement of material comprising:

a shock-resistant container;

an electret microphone for measuring elastic properties of the material; the electret microphone being mounted in the container via an intermediate shock-absorbent material; and

an electric connection for coupling the electret microphone to a controller.

According to a fourth aspect of the present invention, there is provided a method for determining the resonance period of a material, the method comprising:

i) providing a plurality of period values obtained by measuring vibrations of a sample of the material during repetitively impacting the sample of the material;

ii) providing an analysis resolution;

iii) grouping the period values into a current series of groups of period values defined by the analysis resolution;

iv) determining the population of period values in each of the groups in the current series of groups;

v) providing an acceptability level;

vi) selecting a subsequent series of groups among the current series of groups, yielding selected groups; the selected groups in the subsequent series of groups having a population equal or greater than the acceptability level;

vii) verifying whether the subsequent series of groups include more than two groups;

viii) if the subsequent series of groups include more than two groups then viii) a) increasing the analysis resolution, viii) b) defining the subsequent series of groups as the current series of groups, and viii) c) repeating steps vi) to viii);

ix) creating a final group of period values including all the period values from the subsequent series of groups and period values from step i) falling within one of the subsequent series of groups; and

x) determining the average of the final group of period values.

The method allows selecting most of the periods corresponding to the resonant frequency emanating from the sample under test and for the creation of many groups of period identified as being identical. Statistically, the group containing the most numerous periods is then identified as representing the periods corresponding to the resonant frequency of the sample.

A first analysis is performed using period values with a resolution for example of 2 bits. Groups are then populated and identified by their population, then retained or rejected. Within the retained groups, another analysis is then repeated with 3 bits of resolution for example. The process is repeated up to 15 bits for example. The final result leads to the identification of two most numerous period groups. Those two groups represent the upper and lower limit of an accepted period value range.

An arithmetic mean is then calculated taking in account all period values within the range leading to the average period value of the main signal, hence the resonant frequency.

Elastic properties that can be measured according to the present invention include but are not limited to flexural frequencies and periods, Elastic Modulus, Shear Modulus and Poisson's ratio.

Finally, according to a fifth aspect of the present invention there is provided a method for characterizing cracks in a material comprising:

a) providing a sample of the material in the form of a rectangular block of material having a height h;

b) measuring the natural flexion resonance period T₁ of the sample along its height;

c) measuring the natural flexion resonance period T₂ of the sample along its width; and

d) computing an equivalent equidistant and uniform length of cracks in the material “a”, such that the distance between the cracks is equal to or lower than said length; wherein
a=abs[h×(1−(T₁/T₂))].

Other objects, advantages and features of the present invention will become more apparent upon reading the following non restrictive description of preferred embodiments thereof, given by way of example only with reference to the accompanying drawings.

### BRIEF DESCRIPTION OF THE DRAWINGS

FIGS. 1a-1b are schematic views of a theoretical rectangular beam including equidistant and uniform cracks on one lateral face and subjected to flexural vibration along a respective orthogonal direction;

FIG. 2 is a schematic view illustrating a system for the elastic properties measurement of a material according to a first illustrative embodiment of a first aspect of the present invention;

FIG. 3 is a schematic view illustrating an impacting device from FIG. 2 according to a first illustrative embodiment of a second aspect of the present invention;

FIG. 4 is a schematic view illustrating an acoustic detection device from FIG. 2 according to a first illustrative embodiment of a third aspect of the present invention;

FIG. 5 is a schematic view illustrating a system for the elastic properties measurement of materials according to a second illustrative embodiment of the first aspect of the present invention;

FIG. 6 is a flow chart illustrating a method for measuring the resonance period of a material according to an illustrative embodiment of a fourth aspect of the present invention;

FIG. 7 is a schematic view illustrating an acoustic detection device according to a second illustrative embodiment of a third aspect of the present invention; and

FIG. 8 is a schematic view illustrating an impacting device according to a second illustrative embodiment of a second aspect of the present invention.

### DETAILED DESCRIPTION

It has been found that defects such as pores and cracks in virgin heterogeneous materials, such as refractories, may be unequally distributed on their boundaries such that the measurement of their flexural resonance period along two orthogonal directions lead to the determination of the defects size on their more damaged boundary. Moreover, the equation from which such determination is achieved can be deduced from the theory concerning the natural flexion resonance frequency of a perfectly elastic rectangular beam. It is to be noted that the afore-mentioned condition is non-realistic with heterogeneous materials such as refractories, which most often present non-elastic behavior.

The natural flexion resonance frequency of the rectangular beam 5 is given by the following two equations:

$$\begin{matrix}f = \frac{1}{T} = \frac{π}{2} \sqrt{\frac{EI}{m {l}^{4}}} & ( 1 ) \\ I = \frac{{bh}^{3}}{12} & ( 2 )\end{matrix}$$

where:
f=Natural flexion resonance frequency [Hz]
T=Natural flexion resonance period (sec)
E=Bulk elastic modulus [Pa]
I=Linear moment of a rectangular beam [m⁴]
l=Specimen length [m]
b=Specimen width [m]

h=Specimen height [m]
m=Linear density [kg/m]
   Thus:
   f∝\sqrt{I} (3)

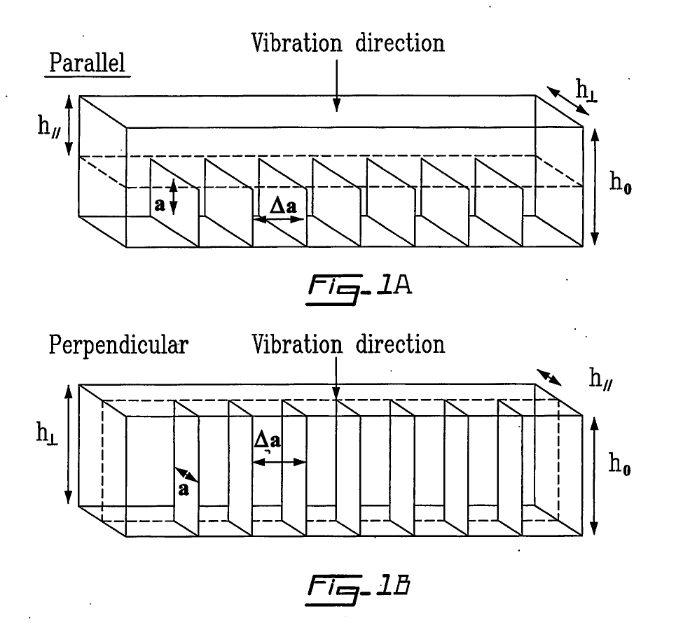

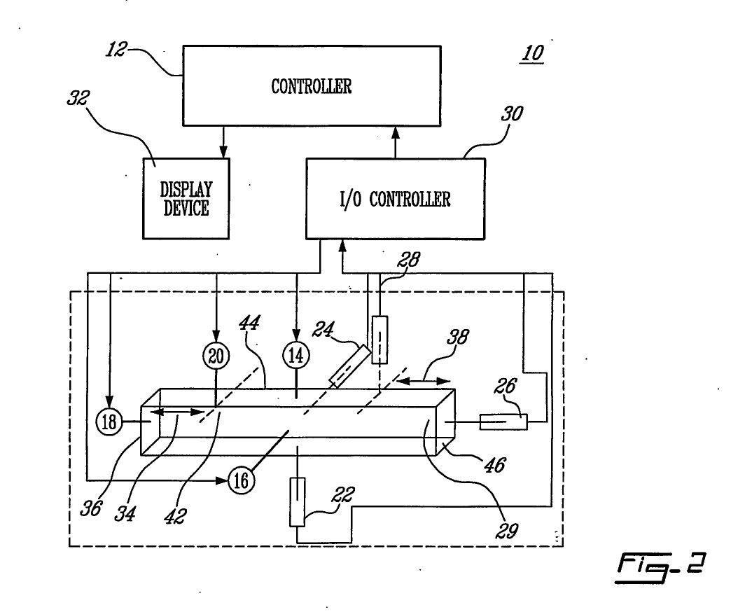

By referring to FIGS. 1A and 1B of the appended drawings illustrating a rectangular beam 5 containing equidistant and uniform cracks on one lateral face and subjected to flexural vibration along two orthogonal directions, the following equations are considered:

$$\begin{matrix}{I}_{//} = \frac{{b}_{//} {h}_{//}^{3}}{12} & ( 4 ) \\ {I}_{⊥} = \frac{{b}_{⊥ /} {h}_{⊥}^{3}}{12} & ( 5 )\end{matrix}$$

Where
I_{//}=Linear moment of the non-damaged region of the rectangular beam 5 parallel to the crack direction [m⁴]
I_{⊥}=Linear moment of the non-damaged region of the rectangular beam 5 perpendicular to the crack direction [m⁴]

From equations (3), (5) and (5), the following Equations can be written:

$$\frac{{f}_{//}}{{f}_{⊥}} = \frac{{h}_{//}}{{h}_{⊥}} \qquad ( 6 )$$

Since the flexion resonance frequency (f) is the inverse of the flexion resonance period (T), equation (6) becomes:

$$\frac{{T}_{⊥}}{{T}_{//}} = \frac{{h}_{//}}{{h}_{⊥}} \qquad ( 7 )$$

According to FIG. 1, the following Equations can be written:
h_{⊥}=hₒ (8)
h_{//}=hₒ−a (9)
Thus:
where a represent

$$a = {h}_{O} ( 1 - \frac{{T}_{⊥}}{{T}_{//}} ) \qquad ( 10 )$$

equidistant and uniform length of cracks in the material, such that the distance between the cracks is equal to or lower than the length.

According to Equation (10), the measurement of the natural flexion resonance period of a perfectly elastic rectangular beam along two orthogonal directions could theoretically lead to the size of the defects in the material being located on its more damaged orthogonal surface with respect to these two directions. This would however be the case only when the distance between these defects is such that it prevents the transfer of vibration between the damaged and non-damaged regions of the beam. This condition is theoretically met when the distance between the cracks is less than their length, as will be shown hereinbelow with reference to Example 2, since in such condition cracks interaction is possible. It has also been observed that this condition may be met within virgin heterogeneous materials such as refractories as will be shown hereinbelow with reference to Example 3. More generally, the value of “a” in Equation (10) could be interpreted as the equivalent equidistant and uniform cracks length in the material, such that the distance between these cracks is less than or equal to their length. It then becomes possible to classify materials with respect to the extent of their damage (number and size of cracks) (see Example 4).

A system 10 for the elastic properties measurement of materials according to a first illustrative embodiment of the present invention will now be described with reference to FIG. 2. More specifically, the system 10 allows for the measurement of resonance periods along different directions of a sample 29.

The system 10 comprises a main controller 12, four impacting devices 14-20 and four high frequency response acoustic detection devices 22-28, each for detecting sound produced by a respective impacting device 14-20 by impacting on a sample 29. The four impacting devices 14-20 and the four acoustic detection devices 22-28 are coupled to the main controller 12 via an input/output (I/O) controller 30.

As will be described hereinbelow in more detail, the acoustic detection devices 22-28 are so positioned relatively to the sample 29 and respective impacting devices 14-20 to capture audio impulse created by impacts of the impacting devices 14-20 on the sample 29 and to produce signals indicative of the captured audio impulse.

The controller 12 is in the form of a personal, laptop, or handheld computer or in any form of computing device provided with a central processing unit (not shown) to process the produced signals and a storage means for storing measurement and computed data.

The I/O controller 30 is in the form of an electronic circuit configured to receive signals from the four acoustic detection devices 22-28. The I/O controller 30 is further configured to calculate periods from the received signals and to send the values to the controller 12 for processing. The I/O controller 30 is further configured to selectively trigger the four impacting devices 14-20 following command signals from the controller 12. The I/O controller 30 may also be in the form of a computer chip or may be part of the controller 12.

The I/O controller 30 is further configured to analyse the received signals using a technique similar to FFT (Fast Fourier Transform) or another similar technique. Each signal is electronically processed with an fast Analog to Digital converter provided with very accurate timing means. Mathematical calculations are made with a data acquisition algorithm allowing to achieve high speed output (<100 mSec) during the prominent resonance period, which corresponds to the average value of up to 2000 consecutive periods collected by the system 10 during each impact. This allows the system 10 higher repeatability than systems and apparatuses from the prior art.

The I/O controller 30 controls single and repetitive hammering of the sample by the impacting devices 14-20. Using a controlled hammering instead of a manual hammering greatly increases chances of repetitive measurements, since a repetitive reading is, amongst other features, sensitive to the hit location.

The system 10 further includes a display device 32 in the form of a display monitor connected to the controller 12 for displaying elastic properties measurement results, for example, as will be explained hereinbelow in more detail.

The controller 30 is configured to display on the display device 32 period readings, allows storing repetitive results and maintains a database that can be consulted further.

The system 10 further comprises a mounting table (not shown) to position the impacting devices 14-20 and acoustic detection devices 22-28 near the sample 29 at appropriate positions for measuring: impacting devices 14 with acoustic detection device 22 for flexural test in a first direction, impacting device 16 with acoustic detection device 24 for flexural test in a second orthogonal direction (with respect to the previous direction), impacting device 18 with acoustic detection device 26 for longitudinal test and impacting device 20 with acoustic detection device 28 for torsional test. The distance 34 between impacting device 20 and surface 36 of the sample 29, as well as the distance 38 between acoustic detection device 28 and surface 40 of the sample is equal to about 0.21 Lₒ, where Lₒ is the length of the sample 29. Impacting device 20 and acoustic detection device 28 are located close to the edge 42 and 44 of the samples 29, respectively.

The impacting devices 14-20 are coupled to the controller 12 via the I/O controller 30 or directly thereto via cables or wirelessly. In that later case, the impacting device includes a receiver and the controller includes an emitter. The controller 12 is configured to remotely control the impacting devices 14-20.

The impacting devices 14-20 are in the form of identical electric hammers so configured and mounted to the sample for repetitively hitting the sample 29 at respective four different locations every time they are triggered. It is to be noted that such impacting repeatability cannot be achieved when the sample 29 is hit with a manual hammer.

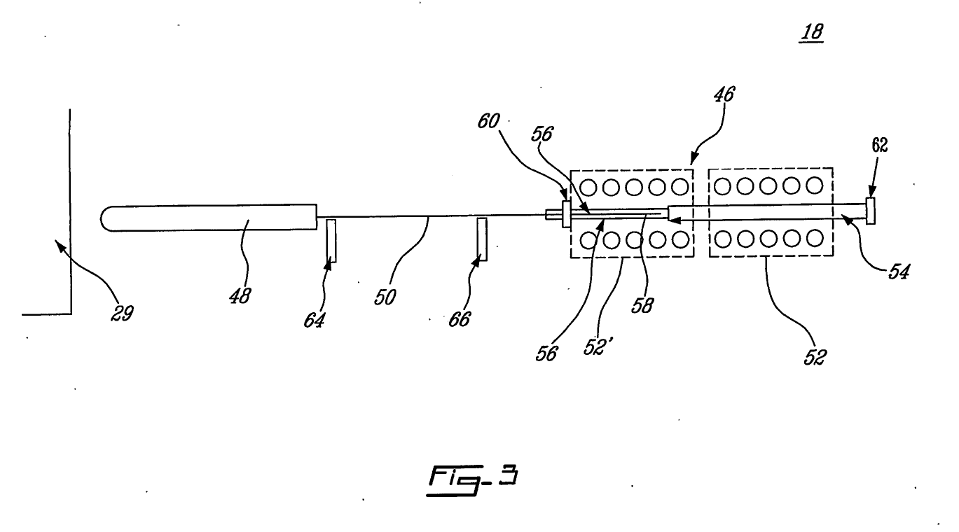

The electric hammer 18 will now be described with reference to FIG. 3.

The hammer 18 comprises an actuator 46 and an impacting tip 48 mounted to the actuator 46 via a thin metallic rod 50.

The actuator 46 includes two solenoid activators 52-52′ coupled in series and sharing a ferromagnetic core 54 made of an iron-based alloy. The core 54 is in the form of a rod. The activators 52-52′ allow for reciprocal movement of the core 54 along the solenoids axis. Of course, the core can be made of any ferromagnetic material.

The intermediate thin metallic rod 50 is configured and sized so as to minimize the mass of the impacting system moving parts. The core 54, intermediate rod 50 and tip 48 are assembled using fastening means such as glue. Of course, other fastening means, including soldering, may also be used. Alternatively, the core 54, intermediate rod 50 and tip 48 are made integral.

The hammer 18 includes a damping assembly 56 for preventing uncontrolled successive impacts following a first sample excitation. The damping assembly 56 includes a spring 58 mounted at the end of the intermediate rod 50 coaxially thereon near the core 54 and two stoppers 60-62 mounted to the hammer 18 so as to be fixedly positioned in relation to the solenoids 52 and 52′. A cylindrical casing (not shown) or another mounting assembly may be used for that purpose.

In operation, the ferromagnetic core 54, after triggering of the hammer 18 and impacting of the tip 48 on the sample 29, is mechanically stopped by the two stoppers 60-62. More specifically, the core 54 first reaches the stopper 60 at its maximum velocity. At this point, the core 54 is suddenly decelerated to zero velocity. Therefore, the other moving parts of the hammer 18, including the spring 58, the intermediate rod 50 and the ceramic impact tip 48 start to loose mass momentum, the loss rate being determined by the spring rigidity, the moving parts velocity and their mass. The hammer 18 and more specifically the damping assembly 56 and configured and sized so that the distance between the impact tip 48 and the sample 29 when the ferromagnetic core 54 is stopped is less than half of the displacement of the impact tip 48 from its initial position when the ferromagnetic core 54 is stopped, and its position when it reaches zero velocity after being decelerated by the spring 58 in the absence of a sample. In such conditions, when the tip 48 reaches the sample 29, the moving parts of the hammer 18 transfer mechanical energy to the sample 29 and then rebounds. The spring 58 then pulls back the moving parts and retains them away from the sample. In such conditions, the synchronization of the solenoids control signals with the moment of impact is not critical, therefore easier to control. It should be noted that the purpose of the second stopper 62 is to limit the course of the core 54 when the moving parts of the hammer 18 return towards the solenoid 52 after impact.

The damping assembly 56 therefore allows limiting the hammer 18 to a single impact per triggering, thereby preventing resonant acoustic signal contamination produced at the beginning of movement transmission.

Indeed, experimental observation has shown that the first part of the signal collected after impacting a heterogeneous material is composed of acoustic noise. Therefore, any uncontrolled successive impacts following the first excitation are undesirable. To prevent repeated impacts, the impact tip 48 is therefore not allowed to rebound on the sample 29.

The hammer 18 finally includes two low friction supports 64-66 for supporting the intermediate rod 50. The two supports 64-66 are distanced as much as possible without interfering with the movement of the moving parts. Therefore, the position of the support 66 is as close as possible from the interface between the tip 48 and the intermediate rod 50 when the hammer is not in operation. Moreover, the position of support 66 is as close as possible to the interface between the intermediate rod 50 and the spring 58 when the maximum course of the moving parts is reached in the impact direction without a sample. This positioning of the supports 64-66 allows free movement and least friction on both supports 64-66 due to reduced bending moment when the impact is in the horizontal direction. Indeed, for repetitive tests, it is preferable to maintain the impact position.

Apart from the mass of the impacting moving parts, their velocity is influenced by both static and dynamic friction coefficients of the two supports 64-66, as well as by the solenoid excitation signal duration and strength. The material of the supports 64-66 is selected such that their static and dynamic friction coefficient is as low as possible to maximize free movement. An example of such materials is Teflon.

The impact tip 48 has a diameter sufficiently small to promote the creation of pure stationary waves under torsion or flexion, which are known to be most efficiently created when impact surface is nearly zero.

The hammer 18 allows movement of the impact tip 48 axially, which allows producing vibration in specific modes (see FIG. 1).

The length of the intermediate rod 50 is such that it minimizes the rod deflection, the static friction coefficient at the supports-rod interfaces as well as the looseness of the impacting moving parts. In such conditions, repetitive sample impacting at locations not differing by more than half the ceramic impact tip diameter, with respect to the targeted location, are achieved.

The impacting velocity of the moving parts is closely controlled to allow sufficient energy transmission to the sample without causing deterioration of the sample 29.

Indeed, to prevent sample impairment during impact, the impact stress does not exceed the sample's strength. This is achieved by increasing the impact surface and/or reducing the impact force. The force is controllable by adjusting the mass and/or the velocity of the moving parts and by providing an impact surface that is greater than the maximum defect size in the sample. For example, refractories frequently contain microstructural defects not exceeding 6 mm. In such a case, the minimal ceramic tip diameter should be 6 mm.

The tip 48 is made long enough to permit convection and/or radiation cooling in such a way to protect the impacting parts. The non-ceramic parts of the hammer 18 are configured so that they do not exceed a temperature higher than the maximum service temperature of the most sensitive part inside the impacting mechanism.

The above dimension limitations dictate the mass of the specific ceramic tip used. With respect to most above criteria, this mass should be minimal. Therefore, the use of tubes with ceramic tips instead of rod is preferred.

The solenoids 52-52′ are configured so that the electrical excitation duration, strength and synchronization are such that (1) the impact tip 48 reaches the sample at a proper velocity as discussed herein, (2) they allow enough time for oscillation attenuation of the impacting moving parts system and (3) they allow retraction of the moving parts to get ready for the next hit.

According to the illustrated embodiment of an impacting device as illustrated in FIG. 3, an electric current passing through the solenoid 52-52′ induces a magnetic field that promotes the displacement of the core 54 along the solenoid axis.

The number of supports 64-66 may of course vary. Alternatively, another intermediate rod supporting means can also be provided, such as an outer cylinder surrounding the intermediate rod 50.

Also, the present invention is not limited to a magnetic impacting device. A pneumatic or hydraulic impacting system can also be used.

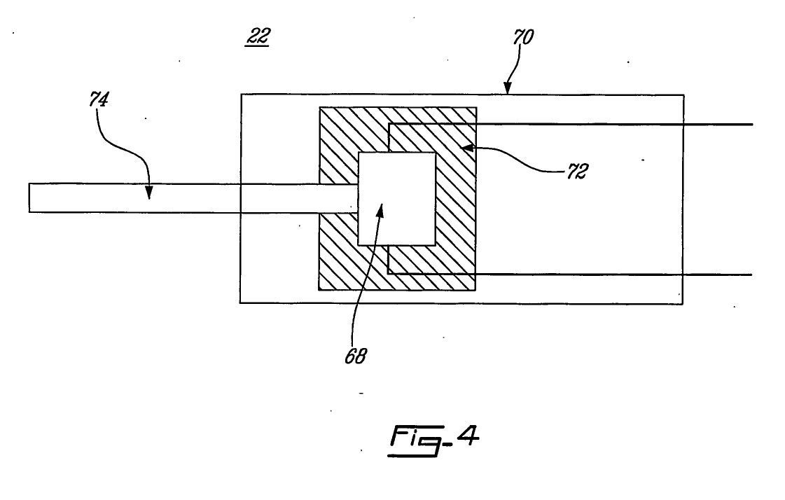

The acoustic detection device 22 will now be described in more detail with reference to FIG. 4. It is to be noted that since the acoustic detection device 24-28 are identical to the acoustic detection device 22, only detection device 22 will be described herein in more detail.

The acoustic detection device 22 comprises a conventional electret microphone 68, which is mounted inside a shock-resistant container in the form of a metallic casing 70. The electret microphone 68 is mounted in an intermediate shock absorbent material 72, which allows securing the microphone 68 in the casing 70 and absorbing mechanical shock. This renders the acoustic detection device 22 durable for industrial use. It is to be noted that the electric connection (not shown) that are used to connect the device microphone 68 to the I/O controller 30 are protected by a strength relied material.

The metallic casing 70 isolates the microphone 68 from electromagnetic perturbations. Indeed, electromagnetic perturbations may constitute another source of noise present in the electrical signal detector output in addition to acoustic environmental noise.

The geometry of the casing 70 is cylindrical having a length, as well as an inner and outer diameters of close to about 3, ⅝ and ¾ inches (about 7.6, 1.6 and 1.9 cm), respectively. The geometry and dimensions of the casing 70 may of course vary.

A waveguide, in the form of metallic tubing 74 is mounted to the microphone 68 and is secured to the casing 70 at one longitudinal end thereof. The waveguide allows for directional acoustic detection to avoid environmental noise capture. This allows increasing period measurement repeatability and accuracy by minimizing environment noise and promoting a clean acoustic signal from the vibrating sample.

For high temperature testing, the use of a waveguide 74 allows to avoid destruction of the device 22 by excessive heat. Such waveguide 74 can be also easily attached to the microphone 68.

The dimensions of the tube 74 determine the directional response of the microphone 68. The length of the tube 74 is at least ten times its inner diameter. The diameter is not smaller than the microphone receiving area, which is a hole typically 2 mm in diameter according to the illustrative embodiment.

The electret microphone 68 allows detection of 20 KHz maximum acoustic vibration, which is the typical maximum resonant frequency to be detected in samples of heterogeneous materials such as refractories and carbon electrodes having minimum dimensions of 0.5×0.5×3 inches, where the acoustic wave velocity is most often lower than 3000 m/s.

Depending on the material to measure and/or the geometry of the sample, another type of microphone can alternatively be used.

The acoustic detecting device 22 is simple and is therefore relatively inexpensive to manufacture.

Other types of acoustic sensors, which are currently available on the market, can also be used. These other types of acoustic sensors can be classified into two categories: electromagnetic microphones and condenser microphones.

Electromagnetic microphones are based on the principle of a moving coil inserted inside a magnetic field. Such device is moved by variable acoustic pressure and translates this variation into an electric signal. Such device has a very low tension output, in the order of millivolts, which therefore requires sophisticated high gain pre-amplification. Moreover, these types of sensors are more prone to destruction under severe mechanical shock than electret microphones.

Condenser microphones are based on the principle of an electrically conductive membrane inserted into a high electric field. The acoustic pressure moves the membrane, therefore changing its tension output compared to the electric field source. This voltage change is representative of the acoustic pressure variation. Such devices are generally used in high accuracy measurements where frequency response must be flat over a wide range, typically between 10 to 100 KHz. Such devices are however more expensive than electret microphones to manufacture.

It is also to be noted that both electromagnetic and condenser microphones are usually much bigger than electrets microphones, which is, for all the above reason, a better choice for the present application.

Electret microphones are similar to the condenser microphones with two major exceptions: (1) the electret microphones do not require a high voltage polarization field since they are pre-polarized and (2) the electret microphones are manufactured with a built-in pre-amplifier, yielding a high detection acoustic sensitivity, which allows to detect very low level energy impact, and a high acoustic pressure ratio, which simplifies the sensor pre-amplification electronic stage of the acquisition system hardware, therefore minimizing its cost.

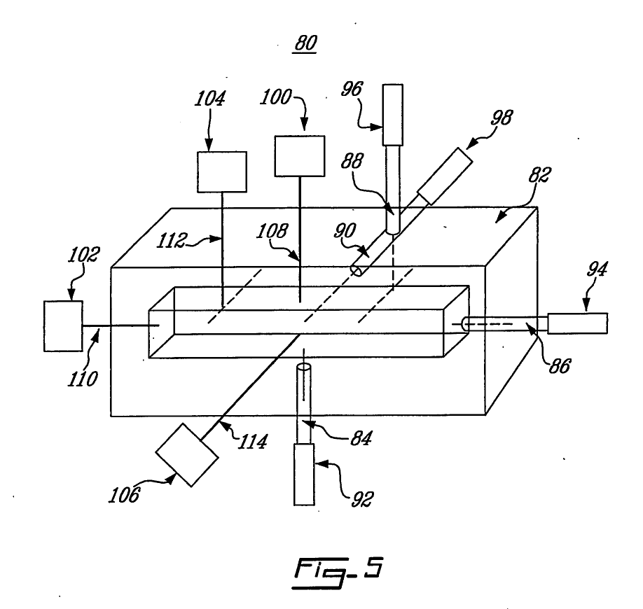

A system 80 for the elastic properties measurement of materials according to a second illustrative embodiment of the present invention will now be described with reference to FIG. 5. Since the system 80 is very similar to system 10 only the differences between the two systems 10 and 80 will be described herein. The system 80 is adapted for high temperature testing.

The system 80 comprises a high-temperature resistant casing, in the form of a furnace 82. Ceramic waveguides 84-90 are mounted to the furnace 82 and respectively receive microphones 92-98 through the furnace 82 lining to collect the audio signals from the sample following impacts obtained using respective electric impacting devices 100-106 coupled with corresponding ceramic impacting tips 108-114 in the form of rod or tubes. The dimensions as well as the composition of these ceramic tips 108-114 are chosen so that they are resistant to the impact energy as well as to the operating temperature and atmosphere inside the furnace 82. The relative position of the hammers 108-114 and microphones 92-98 are as in the case of the system 10.

Ceramic rods or tubes are used as impact tips or any other materials which are resistant to the furnace operating temperature and atmosphere, as well as to high temperature mechanical impact and thermal shock. Examples of such materials include advanced ceramics, such as alumina, mullite, silicon nitride, silicon carbide and boron carbide. In cases where the ceramic impact tip 108-114 is made of a tube, the tube is provided with a closed end for hitting the sample. Moreover, the closed end has a radius of curvature equal to the tube diameter. Such curvature allows the toleration of imperfect hitting angle, i.e. angle departing substantially from 90 degrees. Such preferred geometry also applies in impacting devices where the ceramic impact tip is made of a rod.

The system 80 allows the impacting mechanism to be at a sufficient distance from the furnace hot zone.

In both cases of systems 10 and 80, the different signals recorded allow the controller to calculate and report the following elastic constants of the sample: Elastic Modulus (in two orthogonal directions), Shear Modulus and Poisson's ratio. The measurement of the flexural resonance period along two orthogonal directions allows for determination of the size of major defects in the aforementioned test samples.

With these two flexural resonance period measurements, the controller 12 is programmed with mathematical equations allowing the calculation of the equivalent equidistant and uniform crack lengths in the sample, such that the distance between these cracks is less or equal to their length.

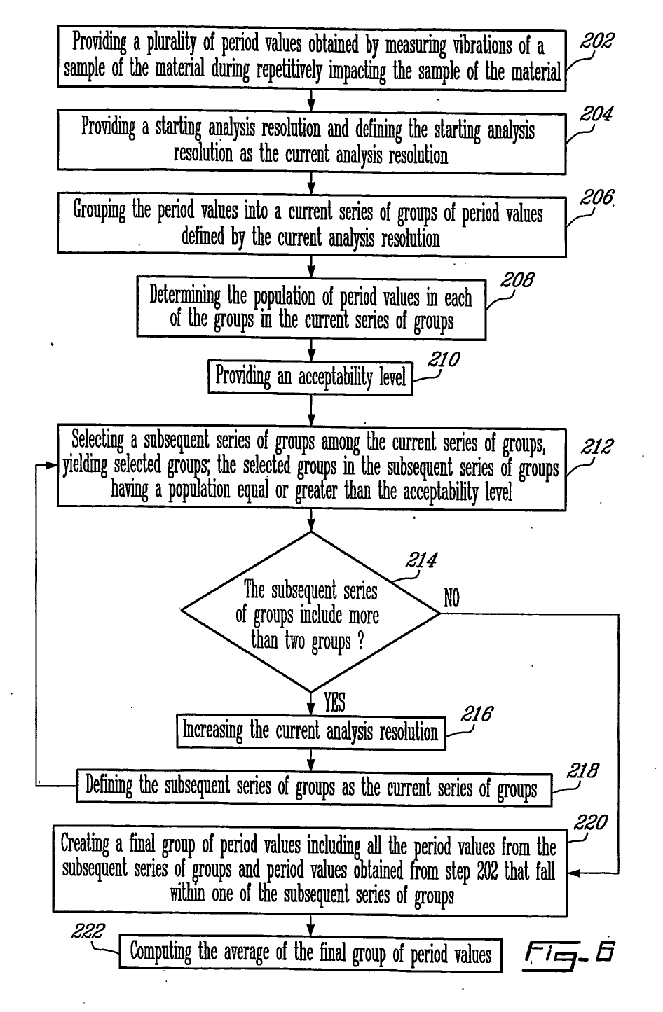

Turning now to FIG. 6 of the appended drawings, a method 200 for the flexural resonance period of a material according to the present invention will now be described.

The method 200 follows the acquisition of data from the system 10 or 80 and allows for calculation of resonance periods from the sample 29. As will be described hereinbelow in more detail, the method 200 includes selectively rejecting or retaining reading points representing one or more resonant frequencies from an electric signal. Once mechanically impacted by the system 10 or 80, the material sample 29 generates acoustic waves captured by the microphones 22-28 or 92-98 and transformed into an electric signal detected electronically by the I/O controller 30.

Data received from the I/O controller 30 includes arithmetic values of the time required for electric signals produced by the acoustic detection devices 22-28 or 92-98 to pass from near one zero volt value to the subsequent near zero volt value. This information is transmitted from the I/O controller 30 in the form of binary data. The binary words represent the elapsed time between one zero volt event and the next one. Except for the first zero volt detection, all subsequent zero volt events are evaluated. As will become more apparent upon reading the following description of the method 200, the method 200 aims treating this information statistically and rendering an average value representing the most repetitive values for each zero volt event.

In resonating material, all values would in theory be identical. In reality, previous experimentation has shown that they are not identical. The method 200 provides for an adequate selection of usable resonant frequency values.

Period values are transmitted to the controller 12 with a resolution sufficient to enable the method 200, implemented in the controller 12, to yield adequate information for determining elastic properties of the material. It has been found that a resolution of 16 bits yields appropriate results. Of course, the I/O controller 30 may be configured to send period values to the controller with another resolution. As will be explained hereinbelow in more detail, the method 200 includes rejecting or accepting acquired period values, by grouping the values. One group is composed of periods for which the values are identical for a resolution from 2 up to 16 bits.

More specifically, in step 202, a plurality of period values obtained by measuring vibrations of the sample 29 along one direction thereof during repetitively impacting the sample 29 of the material along that direction are provided.

In step 204, a starting analysis resolution is provided. This starting analysis resolution is defined as the current analysis resolution for the next steps.

The period values are grouped into a series of groups of period values defined by the current analysis resolution (step 206).

The population of period values in each of the groups in the current series of groups is determined in step 208.

The first analysis resolution is arbitrarily established to 2 bits. Other starting resolutions can also be adequate and is believe to be within the scope of the present invention.

In step 210, an acceptability level is provided to discriminate between the current groups which one to keep and which one to reject.

To achieve this, the population of the most populated group is first determined. This value will be used as a comparison reference for accepting or rejecting all other groups. The acceptability level is calculated by multiplying the most populated group number of individual identical values by a predetermined ratio. This value becomes the level at which the compared group is evaluated. The ratio is arbitrarily established to have a value of ⅓. Other ratio values may be alternatively be used.

In step 212, a subsequent series of groups is selected among the current series of groups. The groups having a population equal or greater than the acceptability level are selected.

It is then verified, in step 214, whether the subsequent series of groups include more than two groups.

When all groups have been either rejected or retained for further analysis, the method 200 continues in step 218 using only retained values from all retained groups, with the exception that one more bit is added to increase resolution (step 216). Alternatively, the resolution may be increased by more than one bit.

A maximum resolution at which the iteration stops can be set. It has been found that a maximum resolution selected within the range of 5 to 15 bits provides good results. The setting is usually efficient at 15 bits but in some severely deteriorated samples, a lower value is preferable.

In all cases, iterations are performed until two groups are retained. The two groups are populated with period values representing the upper and lower limits.

A final group of period values is then created including all the period values from the subsequent series of groups, which include the upper and lower groups, and period values obtained from step 202 that fall within one of the subsequent series of groups (step 220).

The average of the final group of period values is then computed in step 222. The sum of all values retained is divided by the number of values thus giving the average value.

It has been found useful to display the discriminated period values on the display device 32.

For example, a table including three columns (not shown) can be displayed, where the first column includes the sequence number of all the period values (increasing order of event) and the second column includes the corresponding accepted value. In this second column, a field corresponding to a rejected remains blank. The third column includes the corresponding rejected value, which remains blank in the cases of an accepted value. A corresponding point by point graphic (not shown) can also be displayed, wherein, for example, the X axis represents each point in time from first to last, and the Y axis represents the value of each point; points rejected or accepted are shown in different colors. Such graphic may give a useful and quick impression of the resonant phenomenon taking place in the sample.

In certain instances, the graphic will display bands of points leading to a perception of repetitive period values not identified by the method. In such a situation, the algorithm parameters could be changed to target more appropriately the desired band of periods.

A well known mathematical approach already exists for treating vibration information is the Fast Fourier Transform (FFT). However, this approach requires a substantial amount of computation and therefore performs slower than the method 200. Furthermore, FFT requires a near infinite signal in order to render information accurately. According to the present invention, vibration information is only available for a very short period of time of the order of ⅕ of a second in most cases. By comparison, the method 200 allows completing an analysis within half a second.

The information received by the I/O controller 30 is comprised of elapsed time values that are often detrimental to the requested answer due to environmental noise and other not too well understood phenomena. The method 200 for determining the resonance period of a sample material according to the present invention has a near perfect ability to distinguish between unusable and usable readings.

Since the method 200 is implemented in the computer 12, it is constantly kept in a state of readiness and therefore computation can commence as soon as a signal arrives from the I/O controller 30.

It has been found through experimentation that the acoustic signal from an excited sample may be very weak and of extremely short duration. The method 200 is adaptable to such a situation by the possibility to modify the comparison criteria, and more specifically the ratio and resolution increase step.

Even though, the method 200 has been described as allowing determining the average resonance period of a material, it can be adapted to determine the average resonance frequency of a material.

First Experimental Example

In this first experimental example, both a system and method for the elastic properties measurement of a material according to an embodiment of the present invention and the Grindo-Sonic (model MK-4) apparatus by J.W. Lemmens Inc. were used to measure the room temperature elastic properties of three pre-fired 230×115×65 mm refractory castable samples. Samples A1 and B1 were prepared from the same silicon carbide-based castable, either pre-fired at 1200° C. (samples A1) or 815° C. (samples B1). Samples C1 was prepared from a zircon-based refractory castable pre-fired at 1200° C.

The results obtained are presented in Tables I to III.

TABLE I
Sample A1

| | |
|---|---|
| GrindoSonic | Microsonic |

| | T | s | T | S |
|---|---|---|---|---|
| L | 100.6 | 0.7 | 101.1 | 0.5 |
| F // | 149.9 | 0.3 | 148.3 | 0.4 |
| F ! | 216.1 | 1.6 | 212.4 | 0.5 |
| T | 199.1 | 0.9 | 200.9 | 0.3 |

TABLE II
Sample B1

| | |
|---|---|
| GrindoSonic | Microsonic |

| | T | s | T | S |
|---|---|---|---|---|
| L | 114.8 | 9.8 | 109.5 | 0.2 |
| F // | 161.4 | 0.3 | 158.2 | 0.7 |
| F ! | 236.0 | 0.3 | 236.1 | 0.2 |
| T | 217.3 | 0.6 | 216.2 | 0.5 |

TABLE III
Sample C1

| | |
|---|---|
| GrindoSonic | Microsonic |

| | T | s | T | S |
|---|---|---|---|---|
| L | 137.7 | 0.2 | 140.5 | 0.1 |
| F // | 213.2 | 1.7 | 210.8 | 0.5 |
| F ! | 300.2 | 1.6 | 293.8 | 0.7 |
| T | 263.0 | 1.2 | 266.0 | 1.2 |

These results includes the average period (T) and their standard deviation (s) values calculated from a series of 30 successive measurements, in both cases, in each tested conditions, i.e., longitudinal (L), flexural in two orthogonal directions (F_{//} and F_{⊥}) and torsional (T).

As can be seen from the above Tables, the method and system from the present invention is, in general, capable of greater repeatability of its results due to its lower corresponding standard deviation values. This is particularly true for sample B1 which, under longitudinal mode, led to results having a standard deviation of about 50 times less with a method and system from the present invention (see Table II). The Grindo-Sonic failed in detecting the more predominant resonance mode when multi-modes propagate simultaneously in the sample (as shown by the large spectrum computed using a method and system from the present invention during testing sample B1 under longitudinal mode).

This first experimental example shows that a method and system for the elastic properties measurement of a material according to the present invention allows more repeatable determinations of the elastic properties of heterogeneous materials as compared to the Grindo-Sonic apparatus.

Second Example

In this example, a 160×30×25 mm aluminosilicate refractory castable sample, pre-fired at 1200° C., was tested with a method and system for elastic properties measurement of a material according to an embodiment of the present invention. The maximum aggregates and defects (pores and/or cracks) size in the sample were about 6.00±0.05 mm and 8.00±0.05 mm, respectively. Prior to the test, a 1 mm thick diamond saw was used to create 15 equidistant and uniform pre-cracks on one lateral face of the sample. The distance between the cracks as well as their length was about 10.00±0.05 mm. This sample was tested under flexural mode along two orthogonal directions with respect to the pre-cracks orientation.

The use of equation (10) for the pre-cracked sample led to a calculated defects size of 9.91±0.03 mm, which is very close to the pre-cracks length.

This second example shows that the length of equidistant and uniform cracks located on one surface of a rectangular beam made of a refractory material may be determine with the use of equation (10) from the measurement of the natural flexion resonance period of the beam along two orthogonal directions.

Third Example

This example is provided in order to show that virgin refractories may contain non-uniformly distributed cracks on their boundaries, such that the distance between these cracks is less than their length, and consequently that the length of these cracks may be determined from equation (10), following the measurement of the natural flexion resonance period of the material along two orthogonal directions.

The results presented in Example 1 for sample C1 tested with a system and method according to an embodiment of the present invention under flexion in two orthogonal directions were determined using equation (10). The calculated defect size value so obtained was 7.69±0.02 mm. The maximum defects (pores and/or cracks) size measured from that sample was about 8.00±0.05 mm.

Fourth Example

This example is provided in order to show that equation (10) may be used to determine the equivalent equidistant and uniform crack lengths in refractories (see the definition given above), allowing the classification of such materials with respect to the extent of their damage (number and size of cracks).

The results presented in Example 1 for sample A1 and B1 tested with a method and system for elastic properties measurement according to an embodiment of the present invention under flexion in two orthogonal directions were introduced into equation (10).

The calculated defect size values so obtained were 1.42±0.08 mm for sample A1 and 0.72±0.14 mm for sample B1, despite the measured defects (pores and/or cracks) size for these two samples being about 6.00±0.05 mm and 12.00±0.05 mm, respectively. Considering the value of “a” in equation (10) as the equivalent equidistant and uniform crack lengths in the material (see previous definition), these results suggest that the amount of defects in sample A1 was higher than that in sample B1. This hypothesis was validated from open porosity measurements from both samples. A higher porosity for sample A1 was effectively obtained (22 vol. % as compared to 18 vol. %).

Fifth Experimental Example

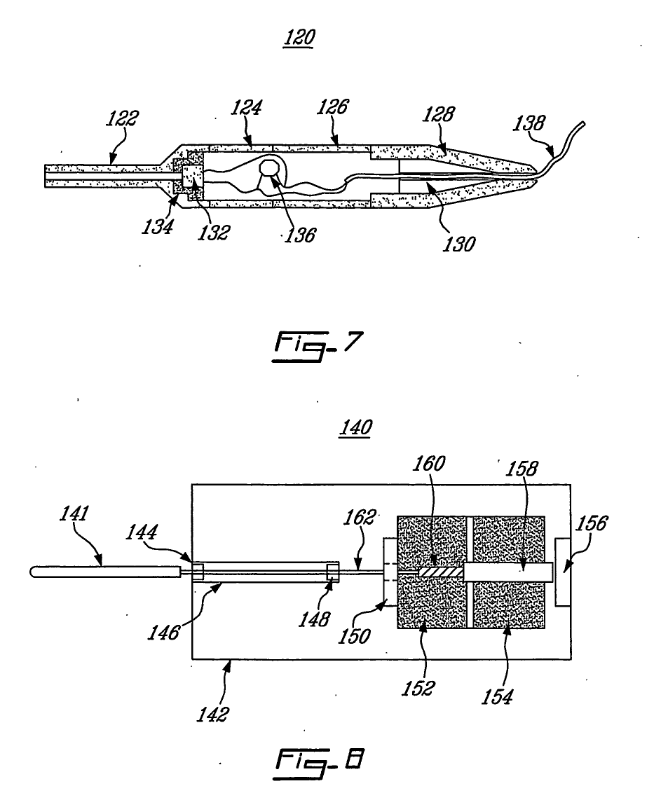

In this fifth example, an acoustic detection device 120 according to a specific implementation of the acoustic detection device 22 is described with reference to FIG. 7.

The casing of the assembly is made from five different parts 122-130 supplied by Neutrix Company, USA. More specifically, the tip 122 corresponds to part no. NM2P, the male-male junction 124 corresponds to part no. NAM1, the male-female casing 126 corresponds to part no. NAM4 and the strain relieve assembly (parts 128-130) corresponds to part no. CM.

The electret microphone 132 is available in bulk quantities from Addison T.V. Parts from Montreal, Canada. It is a 20 KHz maximum frequency response microphone and is in the form of a cylinder 5 mm diameter and 4 mm long. The mechanical shock absorber 134 is made of electronic grade silicon. In this assembly, a 1 nF none polarized 50 volts capacitor 136 is connected in parallel with the electret microphone 132 to further filter the electric signal. The connection wire 138 is made of a shielded wire and is used to connect the acoustic detection device 120 to the I/O controller 30.

Sixth Example

In this example, an impacting device 140 according to a specific implementation of the impacting device 18 is described with reference to FIG. 8.

The casing 142 contains the following components:
144: Front support made of a teflon cylinder, 1.27 cm (½ inch) length and 1.27 cm (½ inch) diameter, with a hole in the center, 0.317 cm (⅛ inch) diameter;
146: Support cylinder, 15.24 cm (6 inch) long with inner and outer diameter of 1.27 cm (½ inch) and 1.58 cm (⅝ inch), respectively. The cylinder is attached to the casing 142;
148: Back support made of a teflon cylinder, 1.27 cm (½ inch) length and 1.27 cm (½ inch) diameter, with a hole in the center, 0.317 cm (⅛ inch) diameter;
150: Front stopper made of silicon material, 1 inch diameter, with a hole in the center, 0.56 cm ( 7/32 inch) diameter. The thickness is 0.635 cm (¼ inch);
152: Front copper wire solenoids having a maximum pulling force of 120 g on the moving core 158. The length is 4.44 cm (1¾ inch). The outer diameter is 2.54 cm (1 inch);
154: Rear copper wire solenoids having a maximum pulling force of 120 g on the moving core 158. The length is 4.44 cm (1¾ inch). The outer diameter is 2.54 cm (1 inch);
156: Rear stopper made of silicon material, 2.54 cm (1 inch) diameter, without central hole. The thickness is 0.635 cm (¼ inch);
158: Ferromagnetic cylindrical core made of iron and having an outer diameter and a length of 0.31 and 5.72 cm (2¼ inch), respectively;
160: Spring made of conventional metallic material and having an elastic constant of about 10 g/mm. The spring inner and outer diameters are 0.31 cm (⅛ inch) and 0.48 cm ( 3/16 inch), respectively. The length is 3.81 cm (1½ inch);
162: The intermediate metallic rod is made of 316SS and has a diameter of 0.31 cm (⅛ inch). The length is 30.48 cm (12 inch).

The ceramic impact tip 141 is made of high purity (>98 weight %) mullite fine ceramic tube having an inner and outer diameter of 0.40 cm ( 5/32 inch) and 0.71 cm ( 9/32 inch), respectively. The length is 30.48 cm (12 inch). The curved end of the tube has a curvature radius of 0.36 cm ( 9/64 inch).

Although the present invention has been described hereinabove by way of preferred embodiments thereof, it can be modified without departing from the spirit and nature of the subject invention, as defined in the appended claims.

### REFERENCES

1. Spinner, S. and Tefft, W. E. “A Method for Determining Mechanical Resonnance Frequencies and for Calculating Elastic Moduli From These Frequencies”. Proceeding ASTM, Vol. 61, pp. 1221-1238.1961.
2. Headrick, W. L. Jr., Moore, R. E. and Leuven, A. V. “Measuring Refractory MOE at High Temperatures”. 2000, http://www.ceramicindustry.com/ci/cda/articleinformation/feature s/bnp features item/0,2710,13644,00.html.
3. Allaire, C. and Talbot. L. “Methods and Apparatus for Non-Destructive Testing of Materials Using Longitudinal Compression Waves”. U.S. Pat. No. 5,040,419. Published Aug. 20, 1991.
4. Ratle, A., Lagacé, M., Pandolfelli, V., Allaire, C., and Rigaud, M. “A Simple Method for Evaluating Elastic Modulus of Refractories at High Temperatures”. J. of the Canadian Ceram. Soc., Vol. 65, No. 3, pp. 202-204. August 1996.
5. “Standard Test Method for Dynamic Young's Modulus, Shear Modulus, and Poisson's Ratio by Impulse Excitation of Vibration”. ASTM E1876-99.
6. “Standard Test Method for Dynamic Young's Modulus, Shear Modulus, and Poisson's Ratio by Sonic Resonance”. ASTM E1875-97.
7. “Standard Test Method for Moduli of Elasticity and Fundamental Frequencies of Carbon and Graphite Materials by Sonic Resonance”. ANSI/ASTM C 747-93.
8. “Standard Test Method for Young's Modulus of Refractory Shapes by Sonic Resonance”. ASTM C885-87(1997).
9. Heritage, K., Frisby, C. and Wolfenden, A. “Impulse Excitation Technique for Dynamic Flexural Measurements at Moderate Temperature”. Rev. Sci. Instrum., 59 [6], 973-974. 1988.

What is claimed is:

1. A system for the elastic properties measurement of a material comprising:
at least one impacting device for impacting a sample of said material so as to produce acoustic vibrations in said sample;
at least one acoustic detection device so positioned relatively to said sample and said impacting device to capture said acoustic vibrations and to produce signals indicative of said acoustic vibrations; and
a controller coupled to both said at least one impacting device and said at least one acoustic detection device for controlling said impacting device, for receiving said signals from said at least one acoustic detection device and for using said signals to determine an elastic property of the material.

2. A system as recited in claim 1, wherein said at least one acoustic detection device is a microphone of a type selected from the group consisting of electret microphone, electromagnetic microphone, and condenser microphone.

3. A system as recited in claim 1, wherein said at least one impacting device is in the form of a hammer for repetitively hitting said sample at a hitting location on said sample.

4. A system as recited in claim 1, wherein said controller is a main controller and at least one of said at least one impacting device and said at least one acoustic detection device is coupled to said main controller via a input/output (I/O) controller.

5. A system as recited in claim 4, wherein said I/O controller is adapted a) to receive said signals indicative of said acoustic vibrations from at least one acoustic detection device, b) to calculate period values from said received signals, and c) to send said period values to the main controller to determine said elastic property of the material.

6. A system as recited in claim 4, wherein said I/O controller includes an analog to digital converter provided with timing means.

7. A system as recited in claim 4, wherein said I/O controller is adapted to selectively trigger said at least one impacting device.

8. A system as recited in claim 1, further comprising a mounting table to position said at least one impacting device and said at least one acoustic detection device near said sample for measuring said sample.

9. A system as recited in claim 1, wherein said at least one impacting device and at least one acoustic detecting device being positioned relatively to said sample for at least one of i) flexural testing in a first direction relatively to said sample, ii) flexural testing in a second orthogonal direction relatively to said first direction, iii) longitudinal testing, and iv) torsional testing.

10. A system as recited in claim 9, wherein said sample is a rectangular beam having two longitudinal end surfaces; said at least one impacting device being positioned at about 0.21 Lₒ from one of said two longitudinal end surfaces for said flexural testing in a second orthogonal direction relatively to said first direction, where Lₒ is the length of said beam.

11. A system as recited in claim 9, wherein said sample is a rectangular beam having two longitudinal end surfaces; said at least one acoustic detection device being positioned at about 0.21 Lₒ from one of said two longitudinal end surfaces for said torsional testing in a second orthogonal direction relatively to said first direction, where Lₒ is the length of said beam.

12. A system as recited in claim 1, further comprising display means connected to said controller for displaying at least one of said elastic property and said signals indicative of said acoustic vibrations.

13. A system as recited in claim 1, wherein said controller includes means for storing data related to at least one of said elastic property and said signals indicative of said acoustic vibrations.

14. A system as recited in claim 1, wherein said at least one impacting device includes an impacting tip; said system further comprising a high-temperature resistant casing including lining for receiving said impacting tip; said system further comprising at least one ceramic waveguide mounted to said casing for receiving said at least one acoustic detection device through said lining of said casing.

15. A system as recited in claim 14, wherein said high-temperature resistant casing being in the form of a furnace for heating said sample.

16. A system as recited in claim 14, wherein said impacting tip is the form of a rod or a tube.

17. A system as recited in claim 16, wherein said tube has a closed end defining said impact tip having a radius of curvature similar to said tube diameter.

18. A system as recited in claim 14, wherein said ceramic is selected from the group consisting of mullite, silicon nitride, silicon carbide and boron carbide.

19. A system as recited in claim 1, wherein the material is homogeneous.

20. A system as recited in claim 19, wherein said homogenous material is a fine ceramic or a metal.

21. A system as recited in claim 1, wherein the material is heterogeneous.

22. A system as recited in claim 21, wherein said heterogeneous material is a refractory or a carbon electrode.

23. An impacting device for causing vibration of a sample of a material in view of measuring an elastic property of the material, the device comprising:
an impacting tip defining a longitudinal axis; and
an actuator for moving said impacting tip along said longitudinal axis; said impacting tip being mounted to said actuator via a rod.

24. An impacting device as recited in claim 23, wherein said impacting tip is in the form of tube.

25. An impacting device as recited in claim 23, wherein said impacting tip is in made of ceramic.

26. An impacting device as recited in claim 23, wherein said impacting tip defines an impact surface which is greater than a maximum defect size in the sample.

27. An impacting device as recited in claim 23, wherein said actuator includes two solenoid activators coupled in series and a ferromagnetic core coaxially mounted within said two solenoid activator for reciprocal movement therein;
whereby, in operation, passing an electric current through said two solenoids induces a magnetic field which causes displacement of said core along said longitudinal axis.

28. An impacting device as recited in claim 23, further comprising a damping assembly for limiting said tip to a single impact following a triggering of said impacting device, thereby preventing resonant acoustic signal contamination.

29. An impacting device as recited in claim 28, wherein said two solenoids have an electrical excitation duration, strength and synchronization yielding sufficient time for oscillation attenuation of the impacting tip and retraction of said impacting tip.

30. An impacting device as recited in claim 28, wherein said damping assembly includes a spring mounted at the end of said rod coaxially thereon near said core, and two stoppers for limiting the longitudinal course of said rod; said two stoppers being fixedly positioned in relation to said two solenoids so that each of said two stoppers is positioned near a respective longitudinal end of said two solenoids.

31. An impacting device as recited in claim 23, further comprising at least one support for supporting said intermediate rod.

32. An impacting device as recited in claim 31, wherein said support is made of a low-friction material.

33. An acoustic detection device for elastic properties measurement of material comprising:
a shock-resistant container;
an electret microphone for measuring elastic properties of the material; said electret microphone being mounted in said container via an intermediate shock-absorbent material; and
an electric connection for coupling said electret microphone to a controller.

34. An acoustic detection device as recited in claim 33, wherein said shock-resistant container is in the form of a metallic casing.

35. An acoustic detection device as recited in claim 33, further comprising a waveguide secured to said casing so as to extend therefrom for mounting said microphone to said casing.

36. An acoustic detection device as recited in claim 35, wherein said waveguide is in the form of a tube; said tube having a length at least about ten times an inner area thereof.

37. An acoustic detection device as recited in claim 36, wherein said electret microphone defines a receiving area; said tube having an aperture greater or equal to said receiving area.

38. A method for determining the resonance period of a material, said method comprising:
i) providing a plurality of period values obtained by measuring vibrations of a sample of the material during repetitively impacting said sample of the material;
ii) providing an analysis resolution;
iii) grouping said period values into a current series of groups of period values defined by said analysis resolution;
iv) determining the population of period values in each of said groups in said current series of groups;
v) providing an acceptability level;
vi) selecting a subsequent series of groups among said current series of groups, yielding selected groups; said selected groups in said subsequent series of groups having a population equal or greater than said acceptability level;
vii) verifying whether said subsequent series of groups include more than two groups;
viii) if said subsequent series of groups include more than two groups then viii) a) increasing said analysis resolution, viii) b) defining said subsequent series of groups as said current series of groups, and viii) c) repeating steps vi) to viii);
ix) creating a final group of period values including all the period values from said subsequent series of groups and period values from step i) falling within one of said subsequent series of groups; and
x) determining the average of said final group of period values.

39. A method as recited in claim 38, further comprising xi) displaying said plurality of period values provided in step i) in the form of a visual representation on a display device; said visual representation being indicative of whether at least one of said plurality of period values is included in said final group.

40. A method as recited in claim 39, wherein said visual representation is a graph or a table.

41. A method as recited in claim 38, wherein said analysis resolution is set to 2 bits in step ii).

42. A method as recited in claim 38, wherein said analysis resolution is increased by 1 bit in substep viii) a).

43. A method as recited in claim 38, wherein said acceptability level is calculated by multiplying the highest population among said population of period values in each of said groups by a predetermined ratio.

44. A method as recited in claim 43, wherein said ratio is about ⅓.

45. A method as recited in claim 38, wherein in step viii) c) verifying whether said analysis resolution is greater than a maximum resolution; if said analysis resolution is greater than a maximum resolution than proceeding with step ix).

46. A method as recited in claim 45, wherein said maximum resolution is 15 bits.

47. A method for characterizing cracks in a material comprising:
a) providing a sample of the material in the form of a rectangular block of material having a height h;
b) measuring the natural flexion resonance period T₁ of said sample along its height;
c) measuring the natural flexion resonance period T₂ of said sample along its width; and
d) computing an equivalent equidistant and uniform length of cracks in the material “a”, such that the distance between said cracks is equal to or lower than said length; wherein
a=abs[h×(1−(T₁/T₂))].
